(19) United States
(12) Patent Application Publication
(10) Pub. No.: US 2015/0270954 A1
(43) Pub. Date: Sep. 24, 2015

(54) DEVICE FOR GENERATING ENCRYPTED DATA SEGMENTS

(71) Applicant: Infineon Technologies AG, Neubiberg (DE)

(72) Inventors: Steven GROSS, Northville, MI (US); Thomas LEMENSE, Farmington, MI (US); James STERLING, Novi, MI (US)

(73) Assignee: Infineon Technologies AG, Neubiberg (DE)

(21) Appl. No.: 14/222,686

(22) Filed: Mar. 24, 2014

(51) Int. Cl. H04L 9/06

(52) U.S. Cl. CPC H04L 9/0618; H04L 2209/24

(57) ABSTRACT

A combination module combines a subset of a plurality of successive data blocks to form a combination block. A cipher module encrypts the combination block to obtain an encrypted combination block. A processing module divides the encrypted combination block into a number of encrypted data segments and combines the number of encrypted data segments with the plurality of successive data blocks to produce a plurality of transmission packets. Each one of the number of encrypted data segments is transmitted less frequently than each one of the plurality of successive data blocks. A communication module outputs the plurality of transmission packets.

### FIELD OF TECHNOLOGY

The present application relates to a device, particularly a device that combines a number of encrypted data segments with a plurality of successive data blocks to produce a plurality of transmission packets.

### BACKGROUND

Within the automotive industry, sensors are used in control systems to sense various parameters of a system. For example, sensors are used in automotive powertrain systems to monitor parameters such as throttle position, fluid pressure and air pressure. These systems rely on unidirectional and bidirectional protocols for communication or networking between the sensors and controllers. Protocols that are known within the automotive industry include the Single Edge Nibble Transmission (SENT) protocol, which is defined by a Society of Automotive Engineers (SAE) J2716 specification. The SENT protocol is a unidirectional protocol which can be used as a digital sensor interface for connecting engine pressure sensors or Hall sensors used to detect valve or pedal positions to an engine controller or Engine Control Unit (ECU). Other protocols include the Short PWM Code (SPC) enhancement of the SENT protocol, and the Peripheral Sensor Interface 5 (PSIS) protocol.

### SUMMARY

According to one embodiment, a device is described herein. The device includes a combination module, a cipher module, a processing module and a communication module. The combination module is operable to combine a subset of a plurality of successive data blocks to form a combination block. The cipher module is operable to encrypt the combination block to obtain an encrypted combination block. The processing module is operable to divide the encrypted combination block into a number of encrypted data segments and combine the number of encrypted data segments with the plurality of successive data blocks to produce a plurality of transmission packets. Each one of the number of encrypted data segments is transmitted less frequently than each one of the plurality of successive data blocks. The communication module is operable to output the plurality of transmission packets.

According to one embodiment, a device is described herein. The device includes a communication module, a processing module, a combination module, a cipher module and a comparison module. The communication module is operable to receive a number of transmission packet sets. Each one of the number of transmission packet sets includes a plurality of received transmission packets that include a plurality of received data blocks and a number of received encrypted data segments. The processing module is operable to extract the plurality of received transmission packets to obtain the plurality of received data blocks and the number of received encrypted data segments and combine the number of received encrypted data segments to form a reference combination block. The combination module is operable to combine a subset of the plurality of received data blocks to form a received combination block. The cipher module is operable to apply a cryptography algorithm to either the reference combination block or the received combination block. The comparison module is operable to compare, after the cryptography algorithm has been applied, the reference combination block with the received combination block and provide an affirmative authentication result if the reference combination block matches the received combination block.

According to one embodiment, a method is described herein. The method includes combining a subset of a plurality of successive data blocks to form a combination block, encrypting the combination block to obtain an encrypted combination block, and dividing the encrypted combination block into a number of encrypted data segments and combining the number of encrypted data segments with the plurality of successive data blocks to produce a plurality of transmission packets. Each one of the number of encrypted data segments is transmitted less frequently than each one of the plurality of successive data blocks. The method further includes outputting the plurality of transmission packets.

According to one embodiment, a method is described herein. The method includes receiving a number of transmission packet sets. Each one of the number of transmission packet sets includes a plurality of received transmission packets that include a plurality of received data blocks and a number of received encrypted data segments. The method further includes extracting the plurality of received transmission packets to obtain the plurality of received data blocks and the number of received encrypted data segments and combining the number of received encrypted data segments to form a reference combination block. The method further includes combining a subset of the plurality of received data blocks to form a received combination block and applying a cryptography algorithm to either the reference combination block or the received combination block. The method further includes comparing, after the cryptography algorithm has been applied, the reference combination block with the received combination block and providing an affirmative authentication result if the reference combination block matches the received combination block.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is a block diagram that illustrates one example of devices configured to communicate according to one or more aspects of this disclosure.

FIG. 2 illustrates a transmission packet format for a transmission packet in accordance with the SENT protocol according to one or more aspects of this disclosure.

FIG. 3 illustrates a diagram of an embodiment of combining data blocks to form a combination block according to one or more aspects of this disclosure.

FIG. 4 is a conceptual diagram that illustrates the transmission of an encrypted combination block over a communication channel according to one or more aspects of this disclosure.

FIG. 5 illustrates a flowchart of an embodiment of method.

FIG. 6 illustrates a flowchart of an embodiment of method.

### DETAILED DESCRIPTION

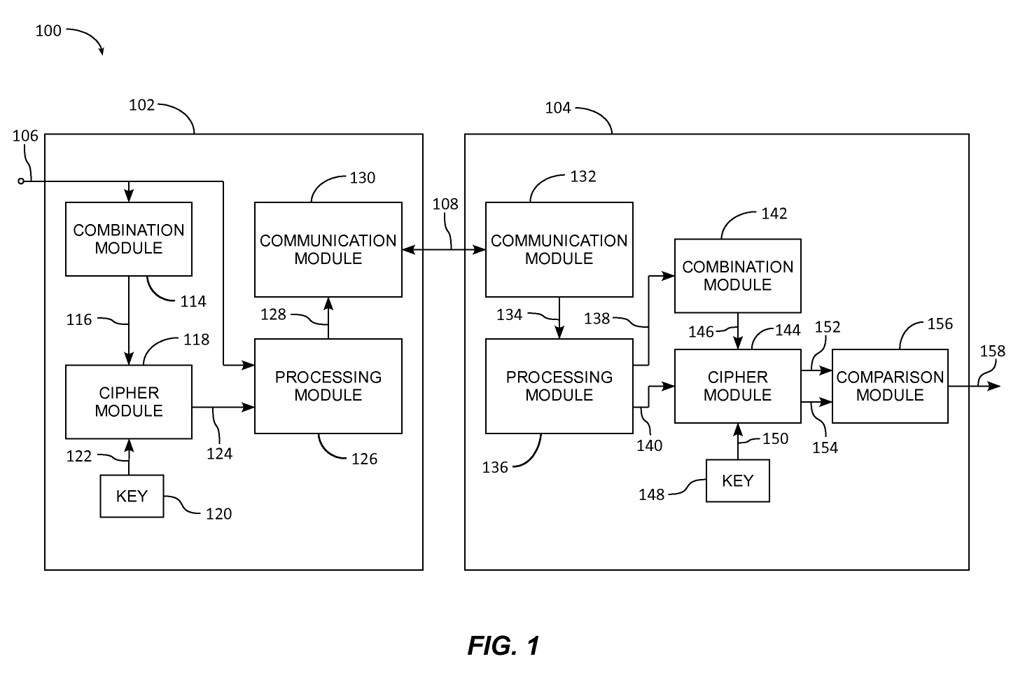

FIG. 1 is a block diagram of a communication system 100 that illustrates a device 102 and a device 104 communicating according to one or more aspects of this disclosure. Device 102 includes combination module 114, cipher module 118, processing module 126 and communication module 130. Combination module 114 and processing module 126 are configured to receive a plurality of successive data blocks via an input 106.

In various embodiments, a sensor (not illustrated) is configured to measure a physical parameter and generate a signal based on the parameter. For example, a pressure sensor measures a pressure and generates a pressure signal based on the pressure. The pressure signal is received by combination module 114 and processing module 126 via input 106 in the form of a digital message or data block. In one embodiment, the data block is a 12-bit data block. In other embodiments, the pressure signal received by combination module 114 and processing module 126 can include one or more data blocks having any suitable size or number of bits.

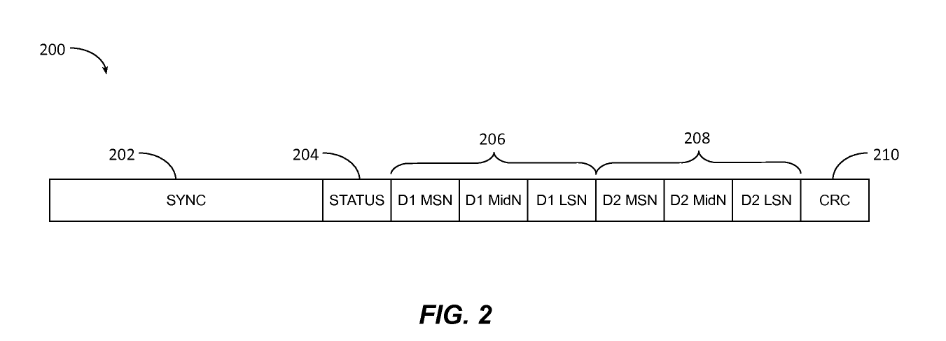

In the illustrated embodiment, each data block is received by combination module 114 and processing module 126 within a communication frame or transmission packet 200 in a serial data signal format that is in accordance with the Single Edge Nibble Transmission (SENT) protocol which is defined by a Society of Automotive Engineers (SAE) J2716 specification (see also, FIG. 2). The SENT protocol is a unidirectional protocol which can be used in the illustrated embodiment and in other embodiments as a digital sensor interface for connecting engine pressure sensors or Hall sensors used to detect valve or pedal positions to an engine controller or Engine Control Unit (ECU). In other embodiments, other suitable signal formats can be used such as the Short PWM Code (SPC) enhancement of the SENT protocol and the Peripheral Sensor Interface 5 (PSI5) protocol.

In the illustrated embodiment, each transmission packet 200 is defined to include a data block 206 and a data block 208. Each data block received by combination module 114 and processing module 126 can include a data block 206, a data block 208, or both data blocks 206 and 208 (hereinafter referred to as data block 206-208). Data blocks 206-208 are continuously received by combination module 114 and processing module 126 via input 106, with one data block 206-208 per transmission packet 200.

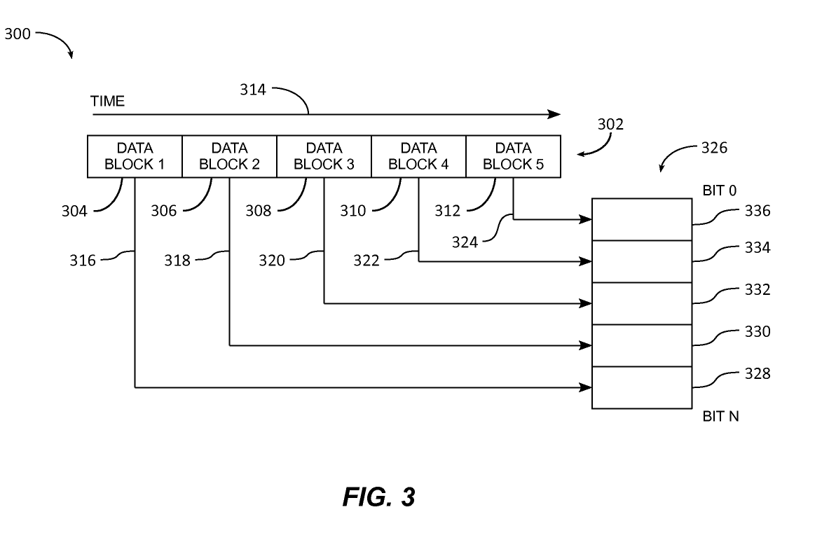

In the illustrated embodiment, combination module 114 receives a plurality of successive data blocks 206-208 at input 106 and is operable to combine a subset 302 of the plurality of successive data blocks 206-208 to form a combination block 326 (see also, FIG. 3). Cipher module 118 receives combination block 326 from combination module 114 via input 116 in a format suitable for encryption by cipher module 118.

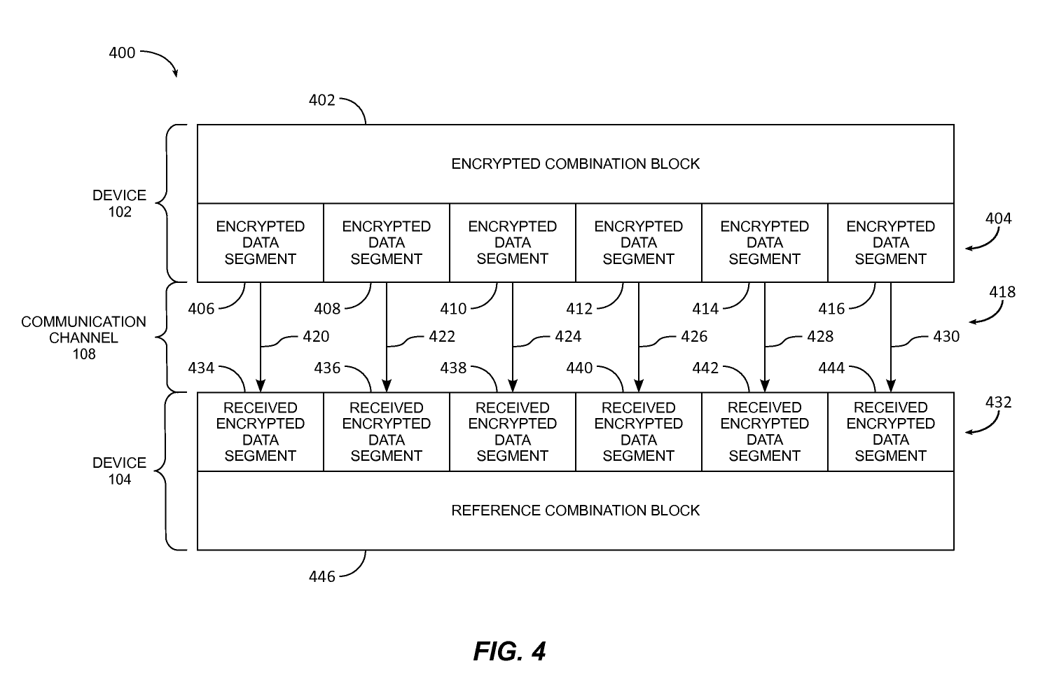

In the illustrated embodiment, cipher module 118 retrieves key 120 via input 122 and uses key 120 to encrypt combination block 326 to obtain an encrypted combination block 402 (see also, FIG. 4). Cipher module 118 can use any suitable type of cryptography algorithm for encrypting or encoding combination block 326 such as a secret key algorithm (symmetric algorithm), a public key algorithm (asymmetric algorithm) or a hash function (one-way encryption algorithm). In one embodiment, cipher module 118 uses the Tiny Encryption Algorithm (TEA) for encrypting combination block 326. In other embodiments, cipher module 118 can use other suitable cryptography algorithms such as the Advanced Encryption Standard (AES) algorithm with cipher key lengths of 128 bits (AES-128) or 256 bits (AES-256). In other embodiments, cipher module 118 can use a cryptography algorithm which is a hash function to encrypt combination block 326. Application of the hash function to combination block 326 produces encrypted combination block 402. Encrypted combination block 402 is a result which is a checksum result. In various embodiments, any suitable hash function can be used. These hash functions include, but are not limited to, a 32-bit Cyclic Redundancy Code (CRC32), a Message-Digest Algorithm 5 (MD5), and a Secure Hash Algorithm (SHA-1).

In the illustrated embodiment, processing module 126 receives encrypted combination block 402 from cipher module 118 via input 124. Processing module 126 divides encrypted combination block 402 into a number of encrypted data segments 404. Processing module 126 also receives the successive data blocks 206-208 via input 106. Processing module 126 combines the number of encrypted data segments 404 with the successive data blocks 206-208 and produces a plurality of transmission packets 200. Communication module 130 receives the plurality of transmission packets 200 from processing module 126 via input 128. Communication module 130 provides the plurality of transmission packets 200 to communication channel 108 in a serial data signal format that is in accordance with the SENT signal format. In other embodiments, other suitable signal formats such as the PSI5 signal format or the SPC signal format can be used.

In the illustrated embodiment, communication channel 108 provides bidirectional communication between communication module 130 within device 102 and communication module 132 within device 104 between at least one node within communication module 130 and at least one node within communication module 132. In one embodiment, communication channel 108 provides unidirectional communication from communication module 130 within device 102 to communication module 132 within device 104.

In one embodiment, processing module 126 appends a subset data block identifier to one or more of the number of encrypted data segments 404 to identify the subset 302 of the plurality of successive data blocks 206-208 that are combined to form combination block 326. Processing module 126 combines the number of encrypted data segments 404 and appended subset data block identifier with the successive data blocks 206-208 to produce the plurality of transmission packets 200. In other embodiments, processing module 126 can append other information to one or more of the number of encrypted data segments 404. This information can include dynamic or time-sensitive information. In one embodiment, processing module 126 appends a timestamp to one or more of the number of encrypted data segments 404. This information can be used, for example, to indicate a time when combination block 326 was formed or when the number of encrypted data segments 404 were formed. In other embodiments, other suitable information such as a counter value can be appended to one or more of the number of encrypted data segments 404.

In the illustrated embodiment, communication channel 108 provides bidirectional communication between device 102 and device 104. In one embodiment, communication module 130 receives a command at channel 108 from device 104 that identifies key 120. The command identifies or selects a key 120 from one or more keys 120 that are stored within device 102. In other embodiments, key 120 is contained within the command. Cipher module 118 is operable to encrypt combination block 326 using the key 120 selected by, or contained within, the command received at channel 108.

In one embodiment, cipher module 118 contains two or more suitable cryptography algorithms. Communication module 130 receives a command at channel 108 that identifies or selects a cipher or cryptography algorithm that cipher module 118 uses or will use to encrypt combination block 326. In one embodiment, the cryptography algorithm selected by the command received at channel 108 is TEA. In other embodiments, the cryptography algorithm selected by the command received at channel 108 can include other suitable cryptography algorithms such as AES-128 or AES-256.

In one embodiment, combination module 114 receives a command via channel 108 that identifies or selects a combination method that combination module 114 uses or will use to combine the subset 302 of the plurality of successive data blocks 206-208 to form combination block 326. In one embodiment, the combination method includes concatenation and combination module 114 concatenates the consecutive subset 302 of the plurality of successive data blocks 206-208 to form combination block 326. In other embodiments, the command received via channel 108 can identify or select other suitable methods or mathematical functions that combination module 114 can use to combine subset 302 of the plurality of successive data blocks 206-208 to form combination block 326.

In one embodiment, cipher module 118 is operable to encrypt combination block 326 using a key 120 that includes a first part and a second part. The first part of key 120 contains information that identifies or is unique to device 102. Processing module 126 appends the first part of key 120 to one or more of the number of encrypted data segments 404. Processing module 126 combines the number of encrypted data segments 404 and the appended first part of key 120 with the successive data blocks 206-208 to produce the plurality of transmission packets 200.

In one exemplary embodiment, cipher module 118 uses TEA for encryption and decryption. The key 120 used for encryption is the same as the key 148 used by cipher module 144 within device 104 for decryption. The size of key 120 used by TEA is 128 bits. The first part of key 120 includes 96 bits and is stored within device 102. The first part of key 120 includes information that is unique to device 102 and can be transmitted to device 104 within transmission packets 200 over communication channel 108. The second part of key 120 includes information that is known only by device 102 and is not transmitted to device 104. In embodiments that include multiple devices 102, each one of the devices 102 can contain the same information within the respective second parts of the keys 120.

In the exemplary embodiment, transferring the first part of key 120 to device 104 enables “plug and play” pairing between device 102 and device 104. In various embodiments, for applications such as automotive applications, this pairing process can be performed only one time, with each ignition cycle, on a periodic or regular basis, or can be initiated by a command received from device 104 over communication channel 108. In other embodiments, this plug and play pairing can be initiated by devices other than device 102 or device 104.

In the illustrated embodiment, device 104 includes communication module 132, processing module 136, combination module 142, cipher module 144 and comparison module 156. Communication module 132 is operable to receive a number of transmission packet sets via communication channel 108. Each one of the number of transmission packet sets includes a plurality of received transmission packets 200 that include a plurality of received data blocks 206-208 and a number of received encrypted data segments 432. Processing module 136 receives the plurality of received transmission packets 200 from each one of the transmission packet sets from communication module 132 via input 134. Processing module 136 extracts the plurality of received transmission packets 120 and obtains the plurality of received data blocks 206-208 and the number of received encrypted data segments 432. Processing module 136 combines the number of received encrypted data segments 432 to form a reference combination block 446. Processing module 136 provides reference combination block 446 to cipher module 144 via output 140. Processing module 136 also provides the plurality of received data blocks 206-208 to combination module 142 via output 138.

The process illustrated in FIG. 3 at 300 is performed by both combination module 114 within device 102 and combination module 142 within device 104. As such, references to FIG. 3 with respect to combination module 142 are denoted with “′” (e.g., subset 302′ and received combination block 326′), while references to FIG. 3 with respect to combination module 114 are not (e.g., subset 302 and combination block 326).

Referring to FIG. 1, combination module 142 combines a subset 302′ of the plurality of received data blocks 206-208 to form a received combination block 326′. In one embodiment, combination module 142 concatenates subset 302′ of the plurality of received data blocks 206-208 to form received combination block 326′. In other embodiments, combination module 142 uses other suitable methods or mathematical functions to combine subset 302′ of the plurality of received data blocks 206-208 to form received combination block 326′. In one embodiment, processing module 136 extracts a subset data block identifier from one or more of the number of received encrypted data segments 432. The subset data block identifier identifies the subset 302′ of the plurality of received data blocks 206-208 that combination module 142 will combine to form received combination block 326′. Cipher module 144 receives received combination block 326′ from combination module 142 via input 146.

In the illustrated embodiment, cipher module 144 applies a cryptography algorithm to either reference combination block 446 or received combination block 326′. The cryptography algorithm can be any suitable type of algorithm such as a secret key algorithm (symmetric algorithm), a public key algorithm (asymmetric algorithm) or a hash function (one-way encryption algorithm). In some embodiments, cipher module 144 provides received combination block 326′ to comparison module 156 via output 152 and provides a result of applying the cryptography algorithm to reference combination block 446 to comparison module 156 via output 154. In one embodiment, the cryptography algorithm applied is a decryption algorithm and cipher module 144 is operable to apply the decryption algorithm to reference combination block 446. In other embodiments, cipher module 144 provides reference combination block 446 to comparison module 156 via output 154 and provides a result of applying the cryptography algorithm to received combination block 326′ to comparison module 156 via output 152. In one embodiment, the cryptography algorithm applied is a hash function, and cipher module 144 is operable to apply the hash function to received combination block 326′. In one embodiment, the cryptography algorithm applied is an encryption algorithm, and cipher module 144 is operable to apply the encryption algorithm to received combination block 326′.

In embodiments where the cryptography algorithm applied is an encryption algorithm or a decryption algorithm, cipher module 144 retrieves key 148 via input 150. If the cryptography algorithm is an encryption algorithm, cipher module 144 uses key 148 to apply the encryption algorithm to received combination block 326′. If the cryptography algorithm is a decryption algorithm, cipher module 144 uses key 148 to apply the decryption algorithm to reference combination block 446. Cipher module 144 can use any suitable algorithm for encryption or decryption. In one embodiment, cipher module 144 uses TEA for encrypting received combination block 326′. In another embodiment, cipher module 144 uses TEA for decrypting reference combination block 446. In other embodiments, cipher module 144 can use other suitable cryptography algorithms for encryption or decryption such as AES-128 or AES-256.

In embodiments where the cryptography algorithm applied is a hash function, cipher module 144 applies the hash function to received combination block 326′. Application of the hash function to received combination block 326′ produces a result which is a checksum result. In various embodiments, any suitable hash function can be used. These hash functions include, but are not limited to, CRC32, MD5 and SHA-1.

In some embodiments, cipher module 144 is operable to encrypt received combination block 326′ or decrypt reference combination block 446 using a key 148 that includes a first part and a second part. Processing module 136 extracts the first part of key 148 from one or more of the number of received encrypted data segments 432 and provides the first part to cipher module 144. The second part of key 148 is stored within device 104 and is available to cipher module 144. If the cryptography algorithm is an encryption algorithm, cipher module 144 uses the first part of key 148 and the second part of key 148 to apply the encryption algorithm to received combination block 326′. If the cryptography algorithm is a decryption algorithm, cipher module 144 uses the first part of key 148 and the second part of key 148 to apply the decryption algorithm to reference combination block 446.

In some embodiments, cipher module 144 applies a cryptography algorithm to reference combination block 446 or received combination block 326′, wherein the cryptography algorithm, key 148, or both the cryptography algorithm and key 148 are the same as that selected within device 102 by a command transmitted from device 104 over communication channel 108 and used by device 102 to form the number of received encrypted data segments 432. One or more devices 102 are operable to receive one or more commands from device 104 over communication channel 108 that identify or select the cryptography algorithm, key 120, or both the cryptography algorithm and key 120 that one or more cipher modules 118 will use to encrypt combination blocks 326.

In one embodiment, the cryptography algorithm is a decryption algorithm and cipher module 144 is operable to apply the decryption algorithm to reference combination block 446 using a key 148 that is the same as that selected within device 102 by a command transmitted from device 104 over communication channel 108 and used by device 102 to form the number of received encrypted data segments 432. In another embodiment, the cryptography algorithm is an encryption algorithm, and cipher module 144 is operable to apply the encryption algorithm to received combination block 326′ using a key 148 that is the same as that selected within device 102 by a command transmitted from device 104 over communication channel 108 and used by device 102 to form the number of received encrypted data segments 432. In yet another embodiment, the cryptography algorithm is a hash function, and cipher module 144 is operable to apply the hash function to received combination block 326′, wherein the hash function is the same hash function as that selected within device 102 by a command transmitted from device 104 over communication channel 108 and used by device 102 to form the number of received encrypted data segments 432.

In the illustrated embodiment, comparison module 156 compares the received combination block 326′ with the reference combination block 446. The comparison is performed after cipher module 144 has applied the cryptography algorithm to either the received combination block 326′ or the reference combination block 446. In one embodiment, the comparison is a bit by bit comparison of the received combination block 326′ with the reference combination block 446. In other embodiments, some or all of the bits within received combination block 326′ are compared with some or all of the bits within reference combination block 446. In other embodiments, any suitable approach can be used for comparing the received combination block 326′ with the reference combination block 446. Comparison module 156 is operable to provide an affirmative authentication result via output 158 if the received combination block 326′ matches the reference combination block 446.

In the illustrated embodiment, comparison module 156 performs the comparison for each one of the transmission packet sets received by device 104. In other embodiments, comparison module 156 can perform the comparison more than once for each received transmission packet set or for selected transmission packet sets. In one embodiment, device 104 receives two transmission packet sets, and comparison module 156 provides an indication at output 158, such as a diagnostic flag or code, if the affirmative authentication result is not provided for both of the two transmission packet sets. In another embodiment, device 104 receives three or more transmission packet sets, and comparison module 156 provides the indication at output 158 if the affirmative authentication result is not provided for at least a majority of the three or more transmission packet sets. In other embodiments, any suitable approach or algorithm can be used by comparison module 156 to determine if the indication at output 158 should be provided.

FIG. 2 illustrates a transmission packet format for a transmission packet 200 in accordance with the SENT protocol according to one or more aspects of this disclosure. The SENT packet 200 has a standard unidirectional signal format and consists of a sequence of pulses illustrated as blocks which are repeatedly sent by a transmitting module such as device 102. The SENT packet 200 includes a synchronization/calibration block 202, a status and serial communication block 204, a data block 206, a data block 208 and a checksum or Cyclic Redundancy Check (CRC) block 210. The synchronization/calibration block 202 identifies the start of the SENT packet 200. In accordance with the SENT protocol, a data nibble is defined to have 4 bits with binary values ranging from 0 to 15. The number of data nibbles is fixed for each application but can vary between applications. The data block 206 and the data block 208 each include up to three 3 nibbles or 12 bits each of user data for a total of six nibbles or 24 bits of user data. The status and serial communication block 204 includes one nibble or 4 bits of status and control information. The status and serial communication block 204 has two unused bits. In the illustrated embodiment, one or both of these bits are used for the number of encrypted data segments 404 within the plurality of transmission packets 200 sent from device 102, as well as the corresponding received encrypted data segments 432 within the plurality of received transmission packets 200 that are received by device 104.

FIG. 3 illustrates a diagram at 300 of an embodiment of combining data blocks to form a combination block according to one or more aspects of this disclosure. The embodiment illustrated at 300 can be used by combination module 114 within device 102 to combine subset 302 of the plurality of successive data blocks 206-208 to form combination block 326. The embodiment at 300 can also be used by combination module 142 within device 104 to combine subset 302′ of the plurality of received data blocks 206-208 to form received combination block 326′.

FIG. 3 illustrates five successive data blocks 206-208 that form subset 302 as data block 1 at 304, data block 2 at 306, data block 3 at 308, data block 4 at 310 and data block 5 at 312. In other embodiments, subset 302 can include any suitable number of data blocks 206-208. In one embodiment, the data blocks 206-208 used to form subset 302 are successive data blocks 206-208 that are received consecutively in time as illustrated at 314. In other embodiments, the data blocks 206-208 used to form subset 302 are not received consecutively in time. In the illustrated embodiment, data blocks 206-208 are continuously transmitted to input 106 or over communication channel 108, with one data block 206-208 per transmission packet 200. Referring to FIG. 3, subset 302 is a consecutive subset of the number of successive data blocks 206-208, and combination module 114 concatenates the consecutive subset of the number of successive data blocks 206-208 to form combination block 326. Data block 1 at 304 is positioned as indicated at 316 to form portion 328 within combination block 326. Data block 2 at 306 is positioned as indicated at 318 to form portion 330 within combination block 326. Data block 3 at 308 is positioned as indicated at 320 to form portion 332 within combination block 326. Data block 4 at 310 is positioned as indicated at 322 to form portion 334 within combination block 326. Data block 5 at 312 is positioned as indicated at 324 to form portion 336 within combination block 326.

In the illustrated embodiment, five data blocks 206-208 are combined to form combination block 326. In other embodiments, any suitable number of data blocks can be combined to form combination block 326. In the illustrated embodiment, data blocks 206-208 within subset 302 are aligned to form combination block 326 with the first data block 206-208 received consecutively in time (data block 1 at 304) forming the highest bit order portion 328 of combination block 326 with respect to Bit 0 and Bit N. In other embodiments, the data blocks 206-208 within subset 302 can be aligned in any suitable order with respect to bit 0 and bit N.

FIG. 4 is a conceptual diagram that illustrates at 400 the transmission of an encrypted combination block 402 over a communication channel 108 according to one or more aspects of this disclosure. In this embodiment, cipher module 118 uses TEA for encrypting combination block 326. Key 120 is a 128 bit key and combination block 326 contains 64 bits. Subset 302 is formed from five successive data blocks 206-208 that each include 12 bits for a total of 60 bits. Each one of the five data blocks 206-208 is included within a transmission packet 200. In accordance with the SENT protocol, the 12 bits are contained within data block 206, data block 208, or portions of data blocks 206 and 208. Combination module 114 concatenates the five successive data blocks 206-208 to form subset 302 and zero-pads subset 302 with 4 bits to form a 64 bit combination block 326. The 64 bits are illustrated in FIG. 3 as bit 0 to bit N where N=63. Cipher module 118 encrypts combination block 326 to obtain encrypted combination block 402 which is provided to processing module 126. Encrypting combination block 326 results in a 64 bit encrypted value which is zero-padded to 72 bits to form a 72-bit encrypted combination block 402. Because a result of applying a cryptography algorithm to combination block 326 can vary depending on the cryptography algorithm used and the size of the combination block 326 used, in some embodiments, the encrypted result is zero-padded to form an encrypted combination block 402 having a size or number of bits that are suitable for subsequent processing within device 102 or device 104.

In the illustrated embodiment, processing module 126 divides the encrypted combination block 402 into a number of encrypted data segments 404. Processing module 126 divides the 72-bit encrypted combination block 402 into six encrypted data segments 404. The six encrypted data segments 404 each include 12 bits (for a total of 72 bits) and are illustrated at 406, 408, 410, 412, 414 and 416. The size of the encrypted data segments 406-416 is selected in accordance with the SENT protocol. The SENT protocol includes a serial data message format that defines how 12 bits of data are incorporated into 18 transmission packets 200. In accordance with the SENT protocol, the size of each encrypted data segment 404 is set at 12 bits. In other embodiments, other suitable sizes can be used for each encrypted data segment 404.

In the illustrated embodiment, processing module 126 combines each one of the six encrypted data segments 404 with 18 transmission packets 200 in accordance with the SENT protocol serial message data format, and communication module 130 provides these 18 transmission packets 200 to communication channel 108. The transmission packets 200 are transmitted in a serial signal format in accordance with the SENT protocol. Each 18 transmission packets are transmitted via communication channel 108, as illustrated at 418, to device 104 as indicated at 420, 422, 424, 426, 428 and 430. A total of 108 transmission packets are used to transmit the 72-bit encrypted combination block 402.

In the illustrated embodiment, communication module 132 within device 104 receives encrypted data segments 432. The received encrypted data segments 432 are illustrated at 434, 436, 438, 440, 442 and 444. The size of each received encrypted data segment 432 is 12 bits. Each set of transmission packets 200 received by communication module 132 includes 108 received transmission packets 200. Communication module 132 provides the 108 received transmission packets 200 to processing module 136. Processing module 136 extracts the 108 received transmission packets 200 and obtains the six received encrypted data segments 432. Processing module 136 combines the six received encrypted data segments 432 to form a 72-bit reference combination block 446.

In the embodiments illustrated herein, each one of the number of encrypted data segments 404 is combined with two or more data blocks 206-208 within two or more transmission packets 200. In the illustrated embodiment, each one of the six encrypted data segments 404 is combined with 18 transmission packets 200. As a result, each one of the number of encrypted data segments 404 is provided or transmitted, within the plurality of transmission packets 200, less frequently or at a lower rate, than each one of the plurality of successive data blocks 206-208.

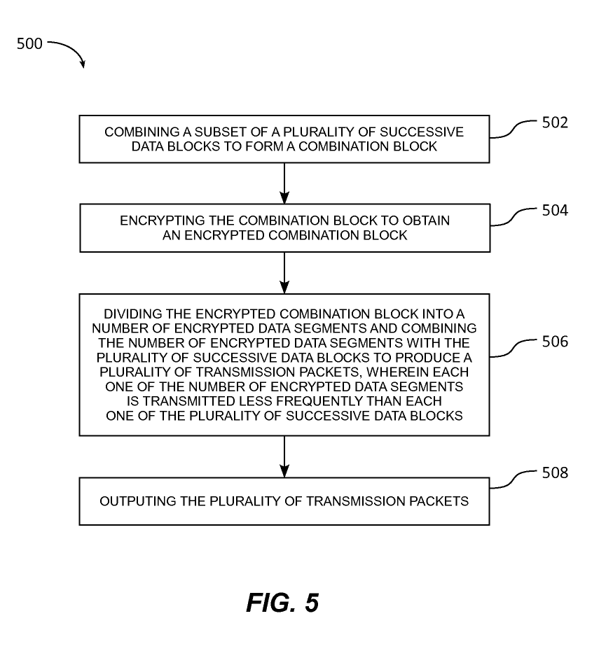

FIG. 5 illustrates a flowchart of an embodiment of a method for device 102. The method is illustrated at 500. Embodiments of method 500 are also described in reference to FIG. 1 through FIG. 4. At 502, a subset 302 of a plurality of successive data blocks 206-208 is combined to form a combination block 326. At 504, the combination block 326 is encrypted to obtain an encrypted combination block 402. At 506, the encrypted combination block 402 is divided into a number of encrypted data segments 404 and the number of encrypted data segments 404 are combined with the plurality of successive data blocks 206-208 to produce a plurality of transmission packets 200. Each one of the number of encrypted data segments 404 is transmitted less frequently than each one of the plurality of successive data blocks 206-208. At 508, the plurality of transmission packets 200 is outputted or provided to a communication channel 108.

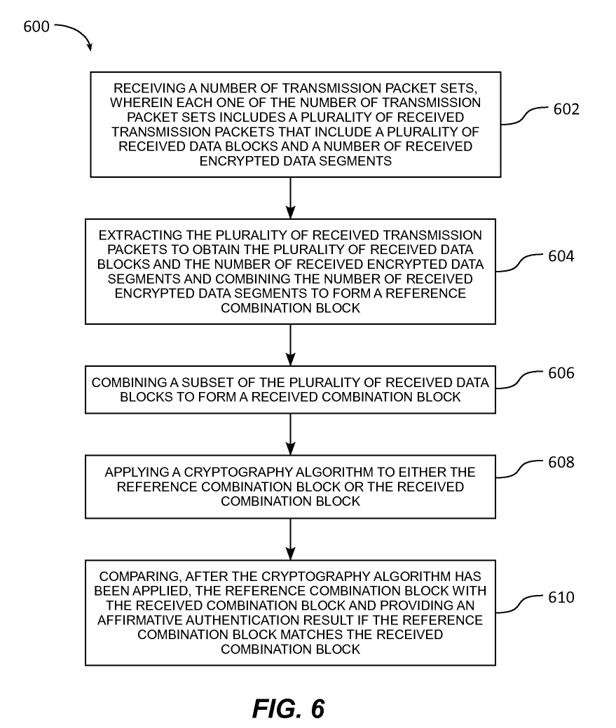

FIG. 6 illustrates a flowchart of an embodiment of a method for device 104. The method is illustrated at 600. Embodiments of method 600 are also described in reference to FIG. 1 through FIG. 4. At 602, a number of transmission packet sets are received, wherein each one of the number of transmission packet sets includes a plurality of received transmission packets 200 that include a plurality of received data blocks 206-208 and a number of received encrypted data segments 432. At 604, the plurality of received transmission packets 200 are extracted to obtain the plurality of received data blocks 206-208 and the number of received encrypted data segments 432, and the number of received encrypted data segments 432 are combined to form a reference combination block 446. At 606, a subset 302′ of the plurality of received data blocks 206-208 are combined to form a received combination block 326′. At 608, a cryptography algorithm is applied to either the reference combination block 446 or the received combination block 326′. At 610, after the cryptography algorithm has been applied, the reference combination block 446 is compared with the received combination block 326′ and an affirmative authentication result is provided if the reference combination block 446 matches the received combination block 326′.

Spatially relative terms such as “under”, “below”, “lower”, “over”, “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A device, comprising:
a combination module operable to combine a subset of a plurality of successive data blocks to form a combination block;
a cipher module operable to encrypt the combination block to obtain an encrypted combination block;
a processing module operable to divide the encrypted combination block into a number of encrypted data segments and combine the number of encrypted data segments with the plurality of successive data blocks to produce a plurality of transmission packets, wherein each one of the number of encrypted data segments is transmitted less frequently than each one of the plurality of successive data blocks; and
a communication module operable to output the plurality of transmission packets.

2. The device of claim 1, wherein each one of the plurality of successive data blocks represents a value measured by a sensor.

3. The device of claim 1, wherein the subset is a consecutive subset of the plurality of successive data blocks, and wherein the combination module concatenates the consecutive subset of the plurality of successive data blocks to form the combination block.

4. The device of claim 1, wherein the processing module is operable to append a subset data block identifier to one or more of the number of encrypted data segments to identify the subset of the plurality of successive data blocks used form the combination block.

5. The device of claim 1, wherein the communication module comprises a bidirectional node, and wherein the cipher module is operable to encrypt the combination block using a key selected by a command received at the bidirectional node.

6. The device of claim 1, wherein the communication module comprises a bidirectional node, and wherein the cipher module is operable to encrypt the combination block using a cryptography algorithm selected by a command received at the bidirectional node.

7. The device of claim 1, wherein the communication module comprises a bidirectional node, and wherein the combination module is operable to combine the subset of the plurality of successive data blocks using a combination method selected by a command received at the bidirectional node.

8. The device of claim 1, wherein the cipher module is operable to encrypt the combination block using a key comprising a first part and a second part, wherein the first part identifies the device, and wherein the processing module is operable to append the first part to one or more of the number of encrypted data segments.

9. The device of claim 1, wherein the cipher module is operable to encrypt the combination block using a hash function.

10. The device of claim 1, wherein the communication module is operable to communicate the plurality of transmission packets in a serial data signal according to a communications protocol selected from the group consisting of:
1. Single-Edge Nibble Transmission (SENT);
2. Peripheral Sensor Interface 5 (PSI5); and
3. Short PWM Code (SPC).

11. A device, comprising:
a communication module operable to receive a number of transmission packet sets, wherein each one of the number of transmission packet sets includes a plurality of received transmission packets that include a plurality of received data blocks and a number of received encrypted data segments;
a processing module operable to extract the plurality of received transmission packets to obtain the plurality of received data blocks and the number of received encrypted data segments and combine the number of received encrypted data segments to form a reference combination block;
a combination module operable to combine a subset of the plurality of received data blocks to form a received combination block;
a cipher module operable to apply a cryptography algorithm to either the reference combination block or the received combination block; and
a comparison module operable to compare, after the cryptography algorithm has been applied, the reference combination block with the received combination block and provide an affirmative authentication result if the reference combination block matches the received combination block.

12. The device of claim 11, wherein one or more of the number of received encrypted data segments includes a subset data block identifier that identifies the subset of the plurality of received data blocks used to form the received combination block.

13. The device of claim 11, wherein the cryptography algorithm is a decryption algorithm, and wherein the cipher module is operable to apply the decryption algorithm to the reference combination block.

14. The device of claim 13, wherein the cipher module applies the decryption algorithm to the reference combination block using a key comprising a first part and a second part, wherein the first part is extracted from one of more of the number of received encrypted data segments by the processing module, and wherein the second part is stored within the device.

15. The device of claim 11, wherein the communication module comprises a bidirectional node, wherein the cryptography algorithm is a decryption algorithm, and wherein the cipher module is operable to apply the decryption algorithm to the reference combination block using a key selected by a command transmitted from the bidirectional node and used to form the number of received encrypted data segments.

16. The device of claim 11, wherein the communication module comprises a bidirectional node, and wherein the cryptography algorithm is selected by a command transmitted from the bidirectional node and used to form the number of received encrypted data segments.

17. The device of claim 11, wherein the cryptography algorithm is a hash function, and wherein the cipher module is operable to apply the hash function to the received combination block.

18. The device of claim 11, wherein the cryptography algorithm is an encryption algorithm, and wherein the cipher module is operable to apply the encryption algorithm to the received combination block.

19. The device of claim 18, wherein the cipher module applies the encryption algorithm to the received combination block using a key comprising a first part and a second part, wherein
the first part is extracted from one or more of the number of received encrypted data segments by the processing module, and wherein the second part is stored within the device.

20. A method, comprising:
combining a subset of a plurality of successive data blocks to form a combination block;
encrypting the combination block to obtain an encrypted combination block;
dividing the encrypted combination block into a number of encrypted data segments and combining the number of encrypted data segments with the plurality of successive data blocks to produce a plurality of transmission packets, wherein each one of the number of encrypted data segments is transmitted less frequently than each one of the plurality of successive data blocks; and
outputting the plurality of transmission packets.

21. A method, comprising:
receiving a number of transmission packet sets, wherein each one of the number of transmission packet sets includes a plurality of received transmission packets that include a plurality of received data blocks and a number of received encrypted data segments;
extracting the plurality of received transmission packets to obtain the plurality of received data blocks and the number of received encrypted data segments and combining the number of received encrypted data segments to form a reference combination block;
combining a subset of the plurality of received data blocks to form a received combination block;
applying a cryptography algorithm to either the reference combination block or the received combination block; and
comparing, after the cryptography algorithm has been applied, the reference combination block with the received combination block and providing an affirmative authentication result if the reference combination block matches the received combination block.
